(19) United States
(12) Patent Application Publication
(10) Pub. No.: US 2026/0118713 A1
(43) Pub. Date: Apr. 30, 2026

(54) DISPLAY PANEL

(71) Applicant: Sharp Kabushiki Kaisha, Sakai City (JP)

(72) Inventors: Yoshinori OHHITSU, Sakai City (JP); Mikihiro NOMA, Sakai City (JP); Hiroshi HASEGAWA, Sakai City (JP); Kenichiroh TSUCHIDA, Sakai City (JP)

(21) Appl. No.: 19/362,609

(22) Filed: Oct. 20, 2025

(30) Foreign Application Priority Data
Oct. 25, 2024 (JP) 2024-188326

(51) Int. Cl. G02F 1/1335

(52) U.S. Cl. CPC G02F 1/133528

(57) ABSTRACT

A display panel includes a screen having a curvature in a first direction, a first absorptive polarizer having an absorption axis orthogonal to the first direction, a first substrate, a liquid crystal layer, a second substrate, and a second absorptive polarizer in this order, and further includes an adhesive layer having an elastic modulus of 1×10⁵ Pa or less at a temperature of 23° C. and a stress relief film between the first absorptive polarizer and the first substrate, in which the stress relief film has a smaller heat shrinkage rate than the first absorptive polarizer at a temperature in a range from 23° C. to 95° C. in a direction parallel to the absorption axis of the first absorptive polarizer.

### CROSS-REFERENCE TO RELATED APPLICATIONS

This application claims the benefit of priority to Japanese Patent Application Number 2024-188326 filed on Oct. 25, 2024. The entire contents of the above-identified application are hereby incorporated by reference.

### BACKGROUND

### Technical Field

The disclosure described below relates to a display panel.

Display panels such as liquid crystal panels are widely used in various devices such as televisions, mobile phones, and displays for PCs. The display panel generally has a configuration in which an optical film such as a polarizer is bonded to a display cell. JP 2017-090555 A, JP 2009-092998 A, JP 2009-003049 A, and JP 2006-106079 A disclose display panels each having a curved screen.

### SUMMARY

FIG. 17 is a schematic plan view illustrating a black display state of a known liquid crystal display panel having a curved screen. FIG. 18 is a schematic perspective view illustrating shrinkage directions of a front polarizer and a back polarizer included in a known liquid crystal display panel having a curved screen. FIG. 19 is a schematic perspective view illustrating absorption axis directions of a front polarizer and a back polarizer included in a known liquid crystal display panel having a curved screen, and a curved direction of the liquid crystal display panel. FIG. 20 is a diagram schematically illustrating stress vectors generated in a color filter substrate included in a known liquid crystal display panel having a curved screen.

As illustrated in FIG. 17, in a known liquid crystal display panel 1R having a curved screen 10R, light leakage may occur at four corners of the screen 10R (liquid crystal display panel 1R). This is remarkably caused in a liquid crystal display panel of a transverse electrical field system such as an in-plane switching (IPS) mode and a fringe field switching (FFS) mode.

As illustrated in FIG. 18, the light leakage increases as the liquid crystal display panel 1R is deformed due to shrinkage and expansion of a front polarizer 410R (for example, a color filter (CF) substrate-side polarizer) and a back polarizer 420R (for example, a thin film transistor (TFT) substrate-side polarizer) included in the liquid crystal display panel 1R.

Since the front polarizer 410R and the back polarizer 420R are stretched in an absorption axis 410AR direction and an absorption axis 420AR direction, respectively, the shrinkage of the front polarizer 410R due to heat is larger in the absorption axis 410AR direction of the front polarizer 410R than in a transmission axis direction of the front polarizer 410R. Similarly, the shrinkage of the back polarizer 420R due to heat is larger in the absorption axis 420AR direction of the back polarizer 420R than in the transmission axis direction of the back polarizer 420R. Since the front polarizer 410R and the back polarizer 420R are arranged so that the absorption axis 410AR and the absorption axis 420AR are orthogonal to each other, the liquid crystal display panel 1R is biaxially deformed by shrinkage.

When a curved cover glass (CG) 700R having a uniaxial curvature parallel to the absorption axis 420AR is bonded to the biaxially deformed liquid crystal display panel 1R as illustrated in FIG. 19, stress-vector angles near the corners (four corners) of the liquid crystal display panel 1R (to be specific, the CF substrate) increase as illustrated in FIG. 20, and light leakage in black display of the liquid crystal display panel 1R increases. Specifically, stress vectors at the four corners of the panel rotate, and light leakage occurs. In the regions other than the four corners of the panel, light is absorbed by the front polarizer 410R and the back polarizer 420R disposed in a crossed-Nicol state, and therefore, light leakage does not occur.

JP 2017-090555 A discloses a technique for reducing light leakage occurring at four corners of a display screen of black display in a curved liquid crystal display panel of the transverse electrical field system. In JP 2017-090555 A, a shrink film that shrinks in a uniaxial direction is attached to a polarizer, and the shrink film is shrunk by heating or drying, thereby curving the liquid crystal display panel. By curving the liquid crystal display panel with the use of the shrink film, stress concentration at the four corners of the liquid crystal display panel is relieved, and light leakage at the four corners of the display screen of black display is reduced. However, it is difficult to sufficiently suppress the expansion and shrinkage of the polarizer with the shrink film, and thus the effect of reducing the light leakage is not sufficient.

In JP 2009-092998 A, the absorption axis of a polarizer on the side where tensile stress is applied is made to coincide with a direction of curvature of a liquid crystal display panel, thereby preventing deterioration of the polarizer and maintaining display characteristics such as contrast. However, the light leakage occurring at the four corners of the display screen (liquid crystal display panel), which is a problem in the liquid crystal display panel of the IPS mode or the FFS mode having a curved screen, is not studied.

In the known liquid crystal display panel, the polarizer expands and shrinks due to the curve of the liquid crystal display panel, and therefore, the absorption axis (polarization axis) of the polarizer may be shifted from the design. As a result, the contrast of the liquid crystal display panel is lowered. In JP 2009-003049 A, a stress relief layer (stress relief film) is disposed on both a front polarizer side and a back polarizer side in order to relieve the expansion and shrinkage of the polarizer. However, when the stress relief film is disposed on both the front polarizer side and the back polarizer side, the warpage of the liquid crystal display panel due to the polarizer is reduced, and light leakage at the four corners of the liquid crystal display panel may be deteriorated.

In JP 2006-106079 A, a liquid crystal display panel is curved by heating a shrink film bonded to one side of the liquid crystal display panel. In the liquid crystal display panel, the liquid crystal display panel is biaxially deformed due to the shrinkage of the polarizer on a counter substrate side, and thus it is considered that the light leakage at the four corners of the panel, which occurs particularly in a liquid crystal display panel of the transverse electrical field system such as the IPS mode and the FFS mode, is not sufficiently improved.

The disclosure has been made in view of the above circumstances, and an object of the disclosure is to provide a display panel capable of suppressing light leakage occurring at a corner of a screen during black display.

(1) An embodiment of the disclosure is a display panel including: a screen having a curvature in a first direction; a first absorptive polarizer having an absorption axis orthogonal to the first direction, a first substrate, a liquid crystal layer, a second substrate, and a second absorptive polarizer in this order; and further including an adhesive layer having an elastic modulus of 1×10⁵ Pa or less at a temperature of 23° C. and a stress relief film between the first absorptive polarizer and the first substrate, in which the stress relief film has a smaller heat shrinkage rate than the first absorptive polarizer at a temperature in a range from 23° C. to 95° C. in a direction parallel to the absorption axis of the first absorptive polarizer.

(2) In the display panel according to an embodiment of the disclosure, in addition to the configuration in (1), the first direction is a short-side direction of the screen, the screen has a curved shape with a central portion protruding toward an observation face side, and the first substrate is located on a side of the screen of the liquid crystal layer.

(3) In the display panel according to an embodiment of the disclosure, in addition to the configuration in (1), the first direction is a longitudinal direction of the screen, the screen has a curved shape with a central portion protruding toward a back face side, and the first substrate is located on a back face side of the liquid crystal layer.

(4) In the display panel according to an embodiment of the disclosure, in addition to the configuration in (1), (2), or (3), a thickness of the adhesive layer is 0.015 mm or more and 0.25 mm or less.

(5) In the display panel according to an embodiment of the disclosure, in addition to the configuration in (1), (2), (3), or (4), a thickness of the stress relief film is 0.01 mm or more and 0.1 mm or less.

(6) In the display panel according to an embodiment of the disclosure, in addition to the configuration in (1), (2), (3), (4), or (5), the stress relief film does not have a phase difference.

According to the disclosure, it is possible to provide a display panel capable of suppressing light leakage occurring at a corner of a screen during black display.

### BRIEF DESCRIPTION OF DRAWINGS

The disclosure will be described with reference to the accompanying drawings, wherein like numbers reference like elements.

FIG. 1 is a schematic plan view of a display panel according to a first embodiment.

FIG. 2 is a schematic side view of the display panel according to the first embodiment when viewed from a direction of A1 in FIG. 1.

FIG. 3 is an enlarged schematic cross-sectional view of the display panel according to the first embodiment taken along line B1-B2 in FIG. 1.

FIG. 4 is a schematic perspective view illustrating a first absorptive polarizer and a second absorptive polarizer.

FIG. 5 is a schematic perspective view illustrating shrinkage of a first absorptive polarizer and a second absorptive polarizer due to heat.

FIG. 6 is a schematic perspective view illustrating a state in which a first absorptive polarizer and a second absorptive polarizer, which have shrunk due to heat, are bonded to each other.

FIG. 7 is a schematic perspective view illustrating a state in which a liquid crystal cell including a first absorptive polarizer and a second absorptive polarizer, which have shrunk due to heat, is bonded to a cover glass having a uniaxial curvature.

FIG. 8 is a diagram illustrating a measurement method of a heat shrinkage rate.

FIG. 9 is a schematic plan view of a display panel according to a second embodiment.

FIG. 10 is a schematic side view of the display panel according to the second embodiment when viewed from a direction of C1 in FIG. 9.

FIG. 11 is an enlarged schematic cross-sectional view of the display panel according to the second embodiment taken along line D1-D2 in FIG. 9.

FIG. 12 is a schematic perspective view illustrating a bending direction of display panels according to Example 1-1, Example 1-2, and Comparative Example 1.

FIG. 13 is a schematic plan view illustrating stress relief in the display panels according to Example 1-1 and Example 1-2.

FIG. 14 is a schematic cross-sectional view illustrating stress relief in the display panels according to Example 1-1 and Example 1-2.

FIG. 15 is a schematic plan view illustrating stress relief in a display panel according to Example 2.

FIG. 16 is a schematic cross-sectional view illustrating stress relief in the display panel according to Example 2.

FIG. 17 is a schematic plan view illustrating a black display state of a known liquid crystal display panel having a curved screen.

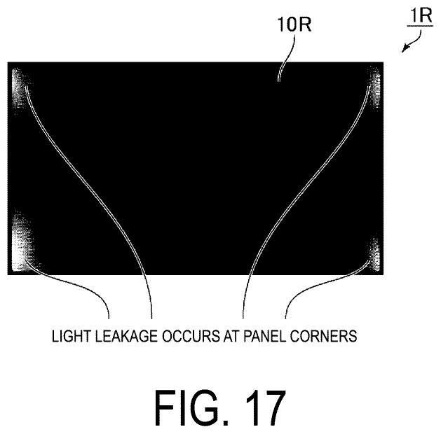

FIG. 18 is a schematic perspective view illustrating shrinkage directions of a front polarizer and a back polarizer included in a known liquid crystal display panel having a curved screen.

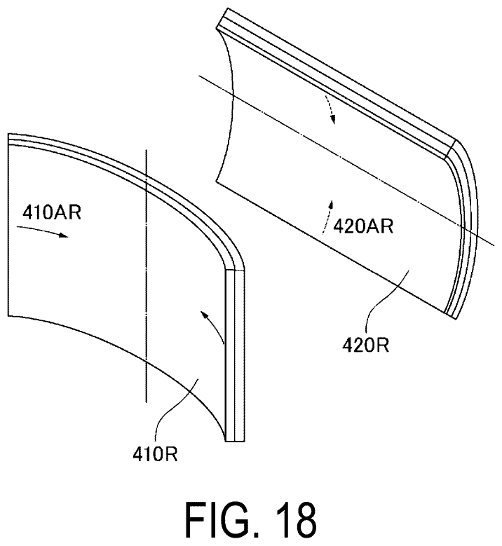

FIG. 19 is a schematic perspective view illustrating absorption axis directions of a front polarizer and a back polarizer included in a known liquid crystal display panel having a curved screen, and a curved direction of the liquid crystal display panel.

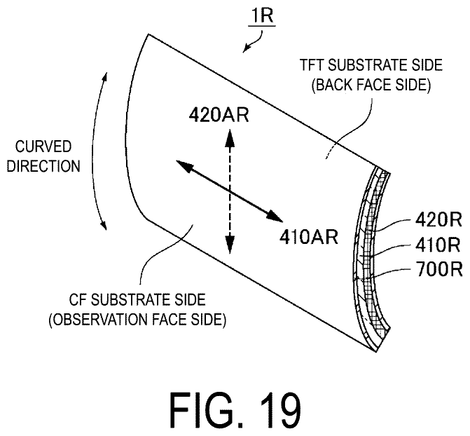

FIG. 20 is a diagram schematically illustrating stress vectors generated in a color filter substrate included in a known liquid crystal display panel having a curved screen.

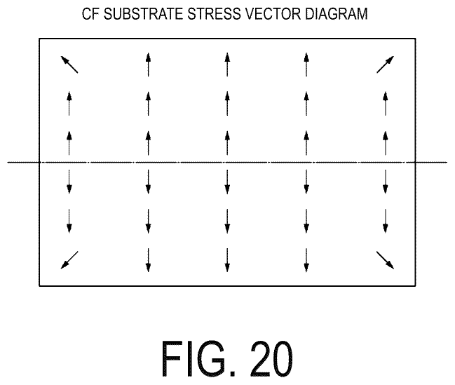

### DESCRIPTION OF EMBODIMENTS

Embodiments according to the disclosure will be described below. The disclosure is not limited to the contents described in the following embodiments, and appropriate design changes can be made within a scope that satisfies the configuration according to the disclosure. In the following description, the same reference numerals are appropriately used in common among the different drawings for the same parts or parts having similar functions, and repeated description thereof will be omitted as appropriate. The aspects of the disclosure may be combined as appropriate within a scope that does not depart from the gist of the disclosure.

### DEFINITION OF TERMS

In the present specification, the observation face side of a certain member refers to a side of the member closer to a viewer, and the back face side of a certain member refers to a side of the member farther from the viewer.

In the present specification, the expression “two straight lines (including axes and directions) are orthogonal to each other” means that the straight lines are orthogonal to each other in a plan view unless otherwise specified. The expression “two straight lines (including axes and directions) are parallel to each other” means that the straight lines are parallel to each other in a plan view unless otherwise specified.

In the present specification, the expression “two axes (directions) are orthogonal to each other” means that an angle (absolute value) formed between both the axes is in a range of 90±1°, preferably in a range of 90±0.5°, and more preferably 90° (completely orthogonal). The expression “two axes (directions) are parallel to each other” means that an angle (absolute value) formed between both the axes is in a range of 0 ±1°, preferably in a range of 0±0.5°, and more preferably 0° (completely parallel).

The term “nx” represents a refractive index in a direction in which an in-plane refractive index has a maximum (i.e., slow axis direction), the term “ny” represents a refractive index in a direction orthogonal to the in-plane slow axis, and the term “nz” represents a refractive index in a thickness direction. The refractive index refers to a value for light having a wavelength of 550 nm at 23° C., unless otherwise specified.

An in-plane phase difference refers to an in-plane phase difference of a layer (film) at 23° C., at a wavelength of 550 nm unless otherwise specified. The in-plane phase difference is obtained by Re=(nx−ny)×d, where d (nm) is a thickness of the layer (film). In the present specification, “phase difference” refers to an in-plane phase difference unless otherwise specified.

A phase difference in the thickness direction (Rth) refers to a phase difference in the thickness direction of a layer (film) at 23° C., at a wavelength of 550 nm unless otherwise specified. Rth is obtained by Rth={(nx+ny)/2−nz}×d, where d (nm) is a thickness of the layer (film).

Embodiments according to the disclosure will be described below. The disclosure is not limited to the contents described in the following embodiments, and appropriate design changes can be made within a scope that satisfies the configuration according to the disclosure.

### First Embodiment

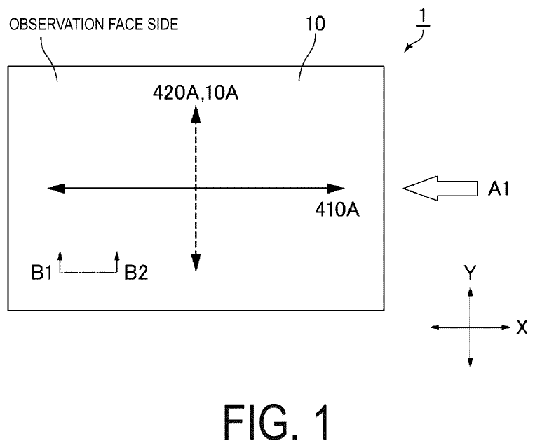

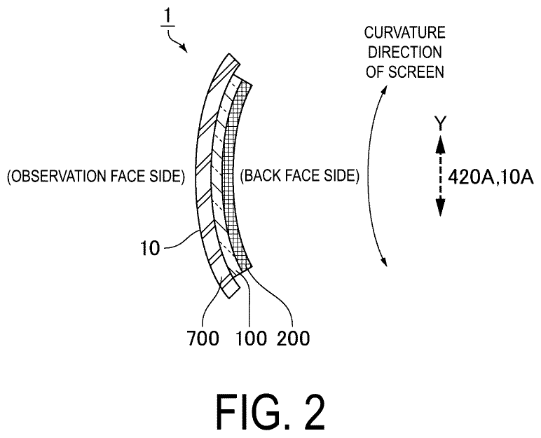

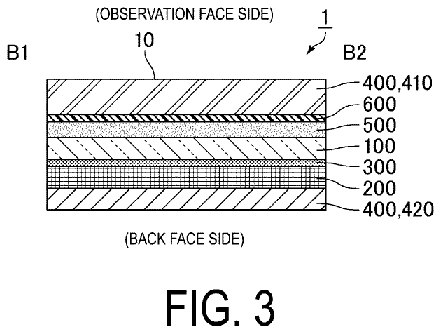

FIG. 1 is a schematic plan view of a display panel according to a first embodiment. FIG. 2 is a schematic side view of the display panel according to the first embodiment when viewed from a direction of A1 in FIG. 1. FIG. 3 is an enlarged schematic cross-sectional view of the display panel according to the first embodiment taken along line B1-B2 in FIG. 1.

As illustrated in FIGS. 1 to 3, a display panel 1 of the present embodiment includes a screen 10 having a curvature in a first direction 10A. The display panel 1 includes a first absorptive polarizer 410 having an absorption axis 410A orthogonal to the first direction 10A, a first substrate 100, a liquid crystal layer 300, a second substrate 200, and a second absorptive polarizer 420 in this order, and further includes an adhesive layer 500 having an elastic modulus of 1×10⁵ Pa or less at a temperature of 23° C. and a stress relief film 600 between the first absorptive polarizer 410 and the first substrate 100, in which the stress relief film 600 has a smaller heat shrinkage rate than the first absorptive polarizer 410 at a temperature in a range from 23° C. to 95° C. in a direction parallel to the absorption axis 410A of the first absorptive polarizer 410. The display panel 1 of such an aspect can relieve the stress due to shrinkage of the first absorptive polarizer 410, suppress biaxial deformation of the display panel 1, and suppress light leakage occurring at a corner of the screen 10 during the black display. Note that in the present specification, the “elastic modulus” refers to an elastic modulus at a temperature of 23° C. unless otherwise specified. The “heat shrinkage rate at a temperature in a range from 23° C. to 95° C.” refers to the “heat shrinkage rate from an environment at a temperature of 23° C. to an environment at a temperature of 95° C.”.

The display panel 1 includes a screen 10 having a curvature in the first direction 10A. A curvature radius R of the screen 10 is, for example, equal to or larger than 800 mm and equal to or less than 5000 mm. The display panel 1 of such an aspect can effectively relieve the stress due to the shrinkage of the first absorptive polarizer 410, effectively suppress the biaxial deformation of the display panel 1, and effectively suppress the light leakage occurring at the corner of the screen 10 during the black display.

In the present embodiment, the first direction 10A is a vertical direction of the screen 10. The screen 10 has a shape that is convex toward the observation face side. The screen 10 has a shape that is concave toward the back face side. That is, the first direction 10A is the short-side direction of the screen 10, the screen 10 has a curved shape with a central portion protruding toward the observation face side, and the first substrate 100 is located on a side of the screen 10 of the liquid crystal layer 300.

The first substrate 100 of the present embodiment is located on the observation face side of the liquid crystal layer 300. Specifically, the display panel 1 of the present embodiment includes the first absorptive polarizer 410, the stress relief film 600, the adhesive layer 500, the first substrate 100, the liquid crystal layer 300, the second substrate 200, and the second absorptive polarizer 420 in this order from the observation face side toward the back face side. The first absorptive polarizer 410 is a polarizer on the observation face side, that is, a front polarizer, and the second absorptive polarizer 420 is a polarizer on the back face side, that is, a back polarizer.

One of the first substrate 100 and the second substrate 200 is a TFT substrate having a plurality of switching elements such as thin film transistors (TFTs), and the other substrate is a counter substrate. The TFT substrate or the counter substrate may include a color filter (CF) of red, green, blue, or the like overlapping a pixel described below.

In the present embodiment, a case in which the first substrate 100 which is a substrate on the observation face side is a counter substrate having a color filter, that is, a CF substrate, and the second substrate 200 which is a substrate on the back face side is a TFT substrate will be described as an example, but the same effect is exhibited even when the first substrate 100 which is a substrate on the observation face side is a TFT substrate and the second substrate 200 which is a substrate on the back face side is a CF substrate.

The TFT substrate (the second substrate 200 in the present embodiment) includes an insulating substrate, and in a display region, on the insulating substrate, a plurality of gate lines extending parallel to each other and a plurality of source lines extending in parallel to each other in a direction intersecting the respective gate lines with an insulating film interposed therebetween. The plurality of gate lines and the plurality of source lines are collectively formed in a lattice pattern so as to partition each pixel. A thin film transistor as a switching element is disposed at an intersection of each gate line and each source line.

The TFT substrate is disposed in each region surrounded by two source lines adjacent to each other and two gate lines adjacent to each other, and includes a pixel electrode that is electrically connected to the corresponding source line with a semiconductor layer included in the thin film transistor interposed therebetween.

The TFT substrate includes a common electrode. That is, the display panel 1 is a display panel of a transverse electrical field system such as a fringe field switching (FFS) mode and an in-plane switching (IPS) mode in which liquid crystal molecules in the liquid crystal layer 300 are aligned parallel to a substrate surface when no voltage is applied. In the display panel 1 of such an aspect, light leakage occurring at the corner of the screen during black display can be effectively suppressed. The display panel 1 applies a predetermined voltage between the pixel electrode and the common electrode to generate an electrical field in the liquid crystal layer 300, and controls an orientation direction of the liquid crystal molecules to control the amount of light transmission.

The first absorptive polarizer 410 has the absorption axis 410A and a transmission axis orthogonal to the absorption axis 410A. The second absorptive polarizer 420 has an absorption axis 420A and a transmission axis orthogonal to the absorption axis 420A. The first absorptive polarizer 410 and the second absorptive polarizer 420 are arranged in a crossed-Nicol state so that the absorption axes 410A and 420A are orthogonal to each other. The absorption axis 410A of the first absorptive polarizer 410 is orthogonal to the first direction 10A. The absorption axis 420A of the second absorptive polarizer 420 is parallel to the first direction 10A. The first absorptive polarizer 410 and the second absorptive polarizer 420 may be collectively referred to as absorptive polarizers 400.

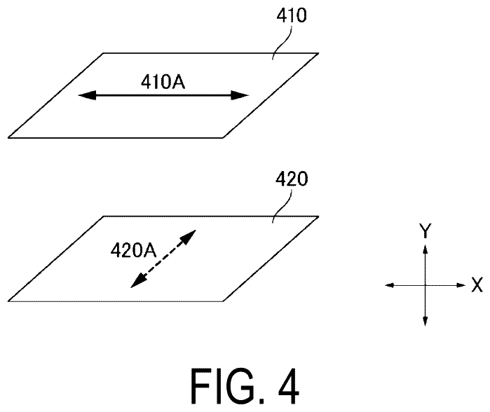

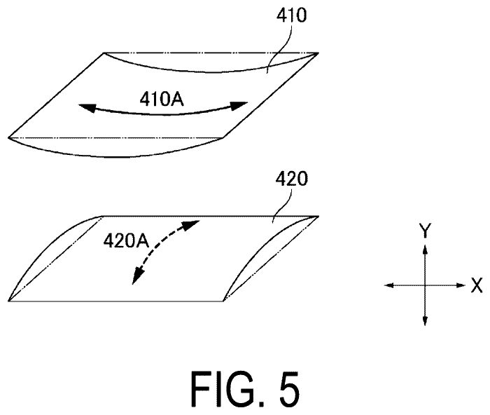

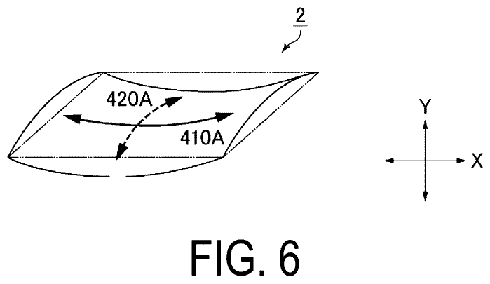

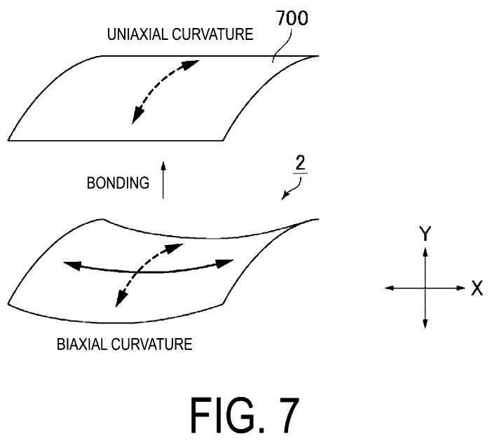

Here, deformation of the display panel due to shrinkage of the polarizer will be described. FIG. 4 is a schematic perspective view illustrating a first absorptive polarizer and a second absorptive polarizer. FIG. 5 is a schematic perspective view illustrating shrinkage of a first absorptive polarizer and a second absorptive polarizer due to heat. FIG. 6 is a schematic perspective view illustrating a state in which a first absorptive polarizer and a second absorptive polarizer, which have shrunk due to heat, are bonded to each other. FIG. 7 is a schematic perspective view illustrating a state in which a liquid crystal cell including a first absorptive polarizer and a second absorptive polarizer, which have shrunk due to heat, is bonded to a cover glass having a uniaxial curvature.

In a liquid crystal display panel of the transverse electrical field system such as the IPS mode or the FFS mode, as illustrated in FIG. 4, the absorption axis 410A of the first absorptive polarizer 410 and the absorption axis 420A of the second absorptive polarizer 420 are set to azimuth angles of 0° and 90°, respectively, and the first absorptive polarizer 410 and the second absorptive polarizer 420 are arranged in a crossed-Nicol state. Here, the polarizer is produced by stretching polyvinyl alcohol (PVA) several times in an absorption axis direction, and has a large residual stress in the stretching direction, and thus, as illustrated in FIG. 5, the polarizer greatly shrinks due to heat. For example, the first absorptive polarizer 410 shrinks in an X-axis direction due to heat, and the second absorptive polarizer 420 shrinks in a Y-axis direction due to heat.

In a case in which the first absorptive polarizer 410 and the second absorptive polarizer 420, which shrink due to heat, are bonded to each other with the liquid crystal layer 300 interposed therebetween as illustrated in FIG. 6 by using an adhesive layer (a pressure sensitive adhesive (PSA)) generally used in bonding a polarizer to a substrate, a display cell 2 to be obtained is deformed (warped) in two axial directions of the X-axis direction and the Y-axis direction due to heat shrinkage after bonding of the first absorptive polarizer 410 and the second absorptive polarizer 420. Here, a thickness of the adhesive layer (PSA) generally used is, for example, 20 μm, and the elastic modulus at a temperature of 23° C. is, for example, 1.5×10⁵ Pa or more.

As illustrated in FIG. 7, in a display panel obtained by attaching a cover glass 700 having a uniaxial curvature to the display cell 2 having such a biaxial curvature, light leakage occurs at four corners of the panel.

However, as described above, the display panel 1 of the present embodiment includes the adhesive layer 500 and the stress relief film 600 between the first substrate 100 and the first absorptive polarizer 410, and thus it is possible to relieve the stress due to the shrinkage of the first absorptive polarizer 410 and to suppress the biaxial deformation of the display panel 1. As a result, light leakage occurring at the corner of the screen 10 during black display can be suppressed.

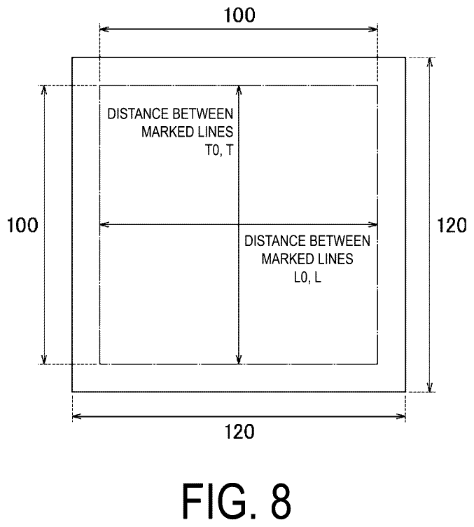

FIG. 8 is a diagram illustrating a measurement method of a heat shrinkage rate. The unit of the numerical values illustrated in FIG. 8 is mm. A test piece having a size of about 120 mm×120 mm is cut out from a target member (polarizer, stress relief film) so that a direction in which the heat shrinkage rate is to be measured is parallel or perpendicular to each side of the test piece. As illustrated in FIG. 8, marks (marks illustrated by alternate long and short dash lines in FIG. 8) are placed on the test piece in a longitudinal direction and a lateral direction so as to be parallel to each side of the test piece. As illustrated in FIG. 8, marks for measuring distances between marked lines (T0 and L0) on a central portion of the test piece are placed, and the distances between marked lines T0 and L0 before heating are measured with a scale ruler capable of measuring distances up to the minimum 0.5 mm in an environment at a temperature of 23° C. and a relative humidity of 60%. Next, the test piece is placed in an environment of 95° C. for 90 minutes, and then held in an environment at a temperature of 23° C. and a relative humidity of 60% for at least 30 minutes, and the distances between marked lines (T and L) after heating are measured again. The changes in the distances between the marked lines in the longitudinal direction and the lateral direction (AT and AL) are calculated, and the heat shrinkage rate is calculated as a percentage with respect to the initial distances between the marked lines.

$$Δ T = \{ \vert T - T 0 \vert / T 0 \} \times 100 \\ Δ L = \{ \vert L - L 0 \vert / L 0 \} \times 100$$

T0 and L0: Distance between marked lines before test (heating) (mm)
T and L: Distance between marked lines after heating (mm)
ΔT: Heat shrinkage rate in the longitudinal direction
ΔL: Heat shrinkage rate in the lateral direction

The liquid crystal layer 300 contains a liquid crystal material. Then, the amount of light transmission is controlled by applying a voltage to the liquid crystal layer 300 to change an alignment state of the liquid crystal molecules in the liquid crystal material in accordance with the applied voltage. The liquid crystal molecules may have a positive or negative value of anisotropy of dielectric constant (Ac) as defined by an equation (LC) given below. The liquid crystal molecules having positive anisotropy of dielectric constant is also referred to as a positive-type liquid crystal, and the liquid crystal molecules having negative anisotropy of dielectric constant are also referred to as a negative-type liquid crystal.

$$Δ ε = ( dielectric constant in major axis direction of liquid crystal molecules ) - ( dielectric constant in minor axis direction of liquid crystal molecules ) \qquad ( LC )$$

An alignment film that controls the orientation direction of the liquid crystal molecules when no voltage is applied may be disposed between the first substrate 100 and the liquid crystal layer 300 and between the second substrate 200 and the liquid crystal layer 300.

The display panel 1 may include the cover glass 700 on the most observation face side. The cover glass 700 has a curved shape that is convex toward the observation face side or the back face side. The display panel 1 is curved in accordance with the shape of the cover glass 700.

The adhesive layer 500 is, for example, an optical clear adhesive (OCA). The adhesive layer 500 is disposed closer to a side of the liquid crystal layer 300 than the stress relief film 600.

The elastic modulus of the adhesive layer 500 at a temperature of 23° C. is 1×10⁵ Pa or less. The elastic modulus of the adhesive layer 500 at a temperature of 23° C. is preferably 5 ×10⁴ Pa or less. The display panel 1 of such an aspect can further relieve the stress due to the shrinkage of the first absorptive polarizer 410 and further suppress the biaxial deformation of the display panel 1. As a result, light leakage occurring at the corner of the screen 10 during black display can be further suppressed.

The elastic modulus can be measured by dynamic viscoelasticity analysis using a rotational rheometer. Examples of the measurement device include “ARES-G2” manufactured by TA Instruments. For example, the measuring mode is set to the vibration mode, the frequency is set to 1 Hz, and the temperature is set to 23° C., and then the elastic modulus can be measured.

A thickness of the adhesive layer 500 is preferably 0.015 mm or more. The display panel 1 of such an aspect can further relieve the stress due to the shrinkage of the first absorptive polarizer 410 and further suppress the light leakage occurring at the corner of the screen 10 during black display. The thickness of the adhesive layer 500 is more preferably 0.025 mm or more.

The thickness of the adhesive layer 500 is preferably 0.25 mm or less. The display panel 1 of such an aspect can suppress deformation (for example, occurrence of a recess) of the adhesive layer 500 in the manufacturing process of the display panel 1. The thickness of the adhesive layer 500 is more preferably 0.1 mm or less.

The thickness of the adhesive layer 500 is preferably 0.015 mm or more and 0.25 mm or less, and more preferably 0.025 mm or more and 0.1 mm or less.

The stress relief film 600 is not particularly limited as long as the heat shrinkage rate of the stress relief film 600 at a temperature in a range from 23° C. to 95° C. in the direction parallel to the absorption axis 410A of the first absorptive polarizer 410 is smaller than that of the first absorptive polarizer 410.

Examples of the stress relief film 600 include an ultra-thin glass (UTG), a film containing polyimide (PI), a film containing triacetyl cellulose (TAC) (also referred to as a TAC film), a film containing polyacrylic acid, and a film containing polymethacrylic acid. Since the polarizer is manufactured by stretching polyvinyl alcohol (PVA), for example, the heat shrinkage rate of a general TAC film is smaller than the heat shrinkage rate of the polarizer.

The heat shrinkage rate of the stress relief film 600 at a temperature in a range from 23° C. to 95° C. in the direction orthogonal to the absorption axis 410A of the first absorptive polarizer 410 is preferably smaller than that of the first absorptive polarizer 410. The display panel 1 of such an aspect can further relieve the stress due to the shrinkage of the first absorptive polarizer 410, can further suppress the biaxial deformation of the display panel 1, and can further suppress the light leakage occurring at the corner of the screen 10 during the black display.

The stress relief film 600 is preferably transparent. The term “transparent” means that the total light transmittance defined by JIS7361-1 (ISO13468-1) is 85% or more.

The stress relief film 600 preferably has no phase difference. With such an aspect, when the display panel 1 includes a viewing angle compensation layer (phase difference layer) closer to the side of the liquid crystal layer 300 than the stress relief film 600, a viewing angle compensation function of the viewing angle compensation layer can be effectively exhibited. The stress relief film 600 having no phase difference means that the in-plane phase difference of the stress relief film 600 is 0 nm or more and 2 nm or less and the phase difference in the thickness direction is 0 nm or more and 10 nm or less. Examples of the stress relief film 600 having no phase difference include “Z-TAC” (manufactured by FUJIFILM Corporation) which is a low retardation TAC.

A linear expansion coefficient of the stress relief film 600 at a temperature in a range from 23° C. to 95° C. is preferably smaller than a linear expansion coefficient of TAC (for example, 5.4×10-5/° C.). The display panel 1 of such an aspect can further relieve the stress due to the shrinkage of the first absorptive polarizer 410, can further suppress the biaxial deformation of the display panel 1, and can further suppress the light leakage occurring at the corner of the screen 10 during the black display. The linear expansion coefficient can be calculated from a difference in the amount of displacement with respect to temperature change by thermomechanical analysis (TMA method). Note that in the present specification, the “linear expansion coefficient at a temperature in a range from 23° C. to 95° C.” refers to the “linear expansion coefficient from an environment at a temperature of 23° C. to an environment at a temperature of 95° C.”.

A thickness of the stress relief film 600 is preferably 0.01 mm or more. The stress relief film of such an aspect has excellent handleability. The thickness of the stress relief film 600 is more preferably 0.025 mm or more.

The thickness of the stress relief film 600 is preferably 0.1 mm or less. The display panel 1 of such an aspect can reduce a thickness of the display panel 1.

Thus, the thickness of the stress relief film 600 is preferably 0.01 mm or more and 0.1 mm or less, and more preferably 0.025 mm or more and 0.1 mm or less.

### Second Embodiment

In the present embodiment, features unique to the present embodiment will be mainly described, and a description of contents overlapping the above-described first embodiment will be omitted. The first substrate 100 included in the display panel 1 of the first embodiment is located on the observation face side of the liquid crystal layer 300, whereas the first substrate 100 included in the display panel 1 of the present embodiment is located on the back face side of the liquid crystal layer 300. As in the first embodiment, the display panel 1 of the present embodiment can also relieve the stress due to the shrinkage of the first absorptive polarizer 410, suppress the biaxial deformation of the display panel 1, and suppress the light leakage occurring at the corner of the screen 10 during black display.

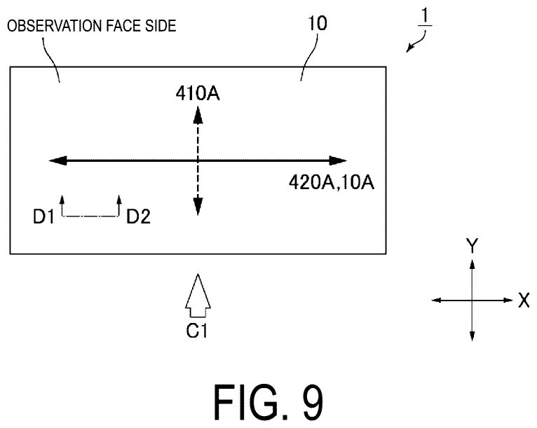

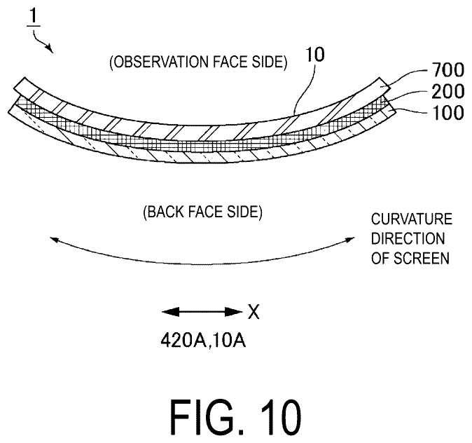

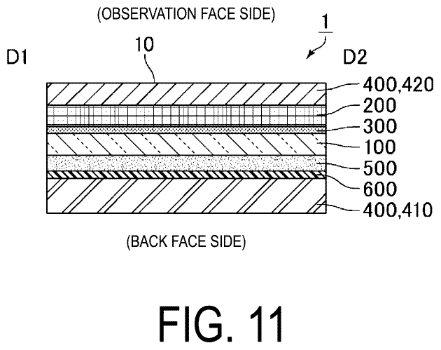

FIG. 9 is a schematic plan view of a display panel according to a second embodiment. FIG. 10 is a schematic side view of the display panel according to the second embodiment when viewed from a direction of C1 in FIG. 9. FIG. 11 is an enlarged schematic cross-sectional view of the display panel according to the second embodiment taken along line D1-D2 in FIG. 9.

As illustrated in FIGS. 9 to 11, the first direction 10A of the present embodiment is a left-right direction of the screen 10. The screen 10 has a shape that is concave toward the observation face side. The screen 10 has a shape that is convex toward the back face side. That is, the first direction 10A is the longitudinal direction of the screen 10, the screen 10 has a curved shape with the central portion protruding toward the back face side, and the first substrate 100 is located on the back face side of the liquid crystal layer 300.

The first substrate 100 of the present embodiment is located on the back face side of the liquid crystal layer 300. Specifically, the display panel 1 of the present embodiment includes, in order from the observation face side toward the back face side, the second absorptive polarizer 420, the second substrate 200, the liquid crystal layer 300, the first substrate 100, the adhesive layer 500, the stress relief film 600, and the first absorptive polarizer 410. The first absorptive polarizer 410 is a polarizer on the back face side, that is, a back polarizer, and the second absorptive polarizer 420 is a polarizer on the observation face side, that is, a front polarizer.

In the present embodiment, a case in which the first substrate 100 which is a substrate on the back face side is a TFT substrate and the second substrate 200 which is a substrate on the observation face side is a CF substrate will be described as an example, but the same effect is exhibited even when the first substrate 100 which is a substrate on the back face side is a CF substrate and the second substrate 200 which is a substrate on the observation face side is a TFT substrate.

The effects of the disclosure will be described below with reference to the examples and comparative examples, but the disclosure is not limited by these examples.

### Example 1-1 and Example 1-2

The display panels 1 of Example 1-1 and Example 1-2 having different thicknesses of the adhesive layer 500 were produced corresponding to the display panel 1 of the first embodiment. Specifically, a display cell in which the liquid crystal layer 300 was disposed between the first substrate 100 (CF substrate) and the second substrate 200 (TFT substrate) was prepared. The first absorptive polarizer 410 (front polarizer, CF substrate-side polarizer) with an adhesive having an absorption axis in the X-axis direction was bonded to a surface of the first substrate 100 included in the display cell on the side opposite to the liquid crystal layer 300 with the stress relief film 600 (“Z-TAC” (manufactured by FUJIFILM Corporation) which is a low retardation TAC) and the adhesive layer 500 (acrylic adhesive, elastic modulus at a temperature of 23° C.: 4.6 ×10⁴ Pa) interposed therebetween. The heat shrinkage rate of the stress relief film 600 at a temperature in a range from 23° C. to 95° C. in the direction parallel to the absorption axis of the first absorptive polarizer 410 was smaller than that of the first absorptive polarizer 410. Next, the second absorptive polarizer 420 (back polarizer, TFT substrate-side polarizer) with an adhesive having an absorption axis in the Y-axis direction was bonded to a surface of the second substrate 200 included in the display cell on the side opposite to the liquid crystal layer 300, thereby obtaining the display panels 1 of Example 1-1 and Example 1-2.

A curvature direction of the screen 10 (cover glass 700) of the display panel 1 of each of Example 1-1 and Example 1-2 was the Y-axis direction, and the screen 10 was curved so as to be convex toward the observation face side. To be specific, the first direction 10A was the short-side direction of the screen 10, the screen 10 had a curved shape with the central portion protruding toward the observation face side, and the first substrate 100 was located on the side of the screen 10 (observation face side) of the liquid crystal layer 300. A thickness of each member is shown in Table 1 below.

TABLE 1

| | Example | Example | Comparative |
|---|---|---|---|
| | 1-1 | 1-2 | Example 1 |
| | Thickness | Thickness | Thickness |
| | (mm) | (mm) | (mm) |
| First absorptive polarizer | 0.1 | 0.1 | 0.1 |
| (CF substrate-side polarizer) | | | |
| Stress relief film | 0.04 | 0.04 | — |
| (Film containing TAC, having no | | | |
| phase difference) | | | |
| Adhesive layer | 0.025 | 0.1 | — |
| (OCA) | | | |
| First substrate | 0.15 | 0.15 | 0.15 |
| (CF substrate) | | | |
| Liquid crystal layer | 0.003 | 0.003 | 0.003 |
| Second substrate | 0.15 | 0.15 | 0.15 |
| (TFT substrate) | | | |
| Second absorptive polarizer | 0.1 | 0.1 | 0.1 |
| (TFT substrate-side polarizer) | | | |

### Comparative Example 1

A display panel of Comparative Example 1 was produced in the same manner as in Example 1-1 and Example 1-2 except that the adhesive layer 500 and the stress relief film 600 were not provided. The thickness of each member is shown in Table 1 above.

### Evaluation of Example 1-1, Example 1-2, and Comparative Example 1

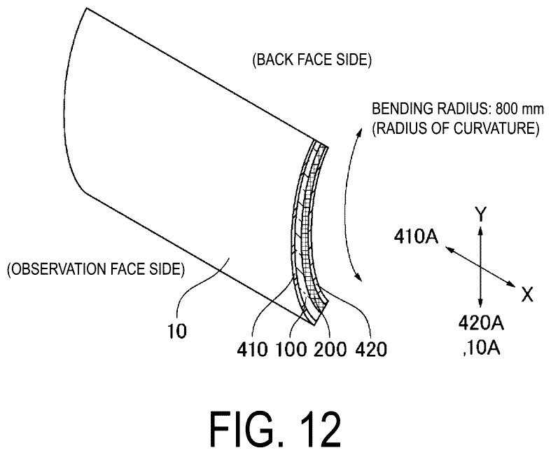

FIG. 12 is a schematic perspective view illustrating a bending direction of the display panels according to Example 1-1, Example 1-2, and Comparative Example 1. In each of the display panels of Example 1-1, Example 1-2, and Comparative Example 1, a cover glass curved in the Y-axis direction was bonded to the observation face side of the first absorptive polarizer, and the screen of the display panel was curved in the Y-axis direction as illustrated in FIG. 12. The curved display panels of Example 1-1, Example 1-2, and Comparative Example 1 were measured for light leakage luminance at the four corners of the display panel during black display.

The light leakage luminance was measured as follows. First, a backlight was provided in each of the display panels of Example 1-1, Example 1-2, and Comparative Example 1 to produce liquid crystal modules. In a state where each of the liquid crystal modules was displayed in black, the luminance was measured from the front surface (observation face side) of the liquid crystal module with a surface luminance meter, and the maximum luminance of each of the liquid crystal modules was calculated. Next, the maximum luminance of each of the liquid crystal modules of Example 1-1 and Example 1-2 was normalized with respect to the maximum luminance of the liquid crystal module of Comparative Example 1, and the light leakage luminance was calculated. The results are shown in Table 2. Note that Table 2 below shows the light leakage luminance of each of Example 1-1 and Example 1-2 when the light leakage luminance of the display panel of Comparative Example 1 is set to 1.0.

TABLE 2

| | Example | Example | Comparative |
|---|---|---|---|
| | 1-1 | 1-2 | Example 1 |
| Light leakage luminance | 0.65 | 0.59 | 1.0 |
| | (−35%) | (−41%) | |

The light leakage luminance was reduced by 35% in the display panel of Example 1-1 and reduced by 41% in the display panel of Example 1-2, as compared with the display panel of Comparative Example 1. The first absorptive polarizer (CF substrate-side polarizer) included in each of the display panels of Example 1-1, Example 1-2, and Comparative Example 1 has an absorption axis in the X-axis direction, and thus the shrinkage in the X-axis direction due to heat is increased. Therefore, biaxial deformation occurs in the display panel in the Y axis (the curvature direction of the cover glass) and the X axis (the shrinkage direction of the CF substrate-side polarizer). However, it is considered that the display panels of Example 1-1 and Example 1-2 could relieve the shrinkage stress of the CF substrate-side polarizer by including the stress relief film 600 and the adhesive layer 500, and could suppress the biaxial deformation of the display panel. As a result, it is considered that the display panels of Example 1-1 and Example 1-2 could suppress light leakage at the corner of the screen as compared with Comparative Example 1. In addition, it is considered that the display panels of Example 1-1 and Example 1-2 can also relieve the stress due to expansion and shrinkage of the CF substrate-side polarizer caused by changes in the environment (humidity, temperature), and thus can maintain stable quality.

### Example 2-1 and Example 2-2

The display panels 1 of Example 2-1 and Example 2-2 corresponding to the display panel 1 of the second embodiment and having different thicknesses of the adhesive layer 500 were produced. Specifically, a display cell in which the liquid crystal layer 300 was disposed between the first substrate 100 (TFT substrate) and the second substrate 200 (CF substrate) was prepared. The first absorptive polarizer 410 (back polarizer, TFT substrate-side polarizer) with an adhesive having an absorption axis in the Y-axis direction was bonded to a surface of the first substrate 100 included in the display cell on the side opposite to the liquid crystal layer 300 with the stress relief film 600 (“Z-TAC” (manufactured by FUJIFILM Corporation) which is a low retardation TAC) and the adhesive layer 500 (acrylic adhesive, elastic modulus at a temperature of 23° C.: 4.6 ×10⁴ Pa) interposed therebetween. The heat shrinkage rate of the stress relief film 600 at a temperature in a range from 23° C. to 95° C. in the direction parallel to the absorption axis of the first absorptive polarizer 410 was smaller than that of the first absorptive polarizer 410. Next, the second absorptive polarizer 420 (front polarizer, CF substrate-side polarizer) with an adhesive having an absorption axis in the X-axis direction was bonded to a surface of the second substrate 200 included in the display cell on the side opposite to the liquid crystal layer 300, thereby obtaining the display panels 1 of Example 2-1 and Example 2-2.

The curvature direction of the screen 10 (cover glass 700) of the display panel 1 of each of Example 2-1 and Example 2-2 was the X-axis direction, and the screen 10 was curved so as to be convex toward the back face side. To be specific, the first direction 10A was the longitudinal direction of the screen 10, the screen 10 had a curved shape with the central portion protruding toward the back face side, and the first substrate 100 was located on the back face side of the liquid crystal layer 300. The thickness of each member is shown in Table 3 below.

TABLE 3

| | Example 2-1 | Example 2-2 |
|---|---|---|
| | Thickness (mm) | Thickness (mm) |
| Second absorptive polarizer | 0.1 | 0.1 |
| (CF substrate-side polarizer) | | |
| Second substrate | 0.2 | 0.2 |
| (CF substrate) | | |
| Liquid crystal layer | 0.003 | 0.003 |
| First substrate | 0.2 | 0.2 |
| (TFT substrate) | | |
| Adhesive layer | 0.025 | 0.1 |
| (OCA) | | |
| Stress relief film | 0.04 | 0.04 |
| (Film containing TAC, having | | |
| no phase difference) | | |
| First absorptive polarizer | 0.1 | 0.1 |
| (TFT substrate-side polarizer) | | |

In the display panels 1 of Example 2-1 and Example 2-2, the shrinkage stress of the TFT substrate-side polarizer could be relieved, and the biaxial deformation of the display panel could be suppressed. As a result, the display panels 1 of Example 2-1 and Example 2-2 could suppress light leakage occurring at the corner of the display panel during black display.

### Evaluation of Example 1-1, Example 1-2, Example 2-1, and Example 2-2

As shown in Examples 1-1, 1-2, 2-1, and 2-2, regardless of whether the screen 10 is curved so as to protrude toward the observation face side (also referred to as convex bending) or curved so as to protrude toward the back face side (also referred to as concave bending), the heat shrinkage stress of the polarizer in the direction orthogonal to the curved direction of the screen 10 is relieved, and thus light leakage occurring at the corner of the screen 10 during black display is suppressed.

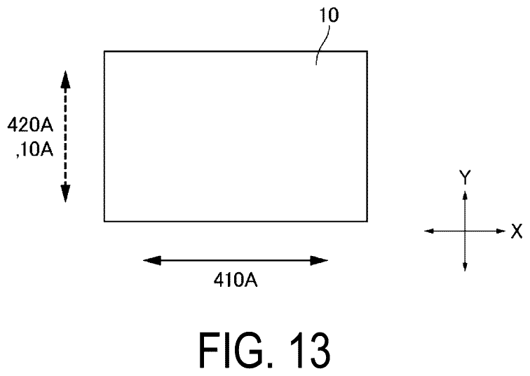

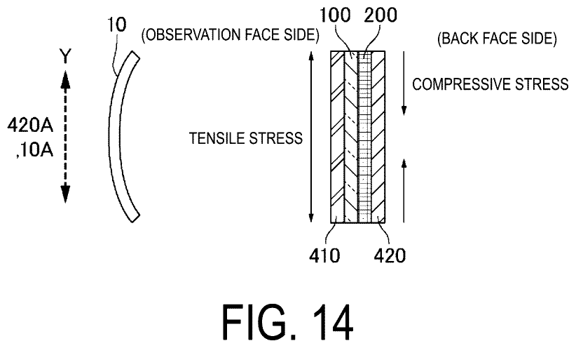

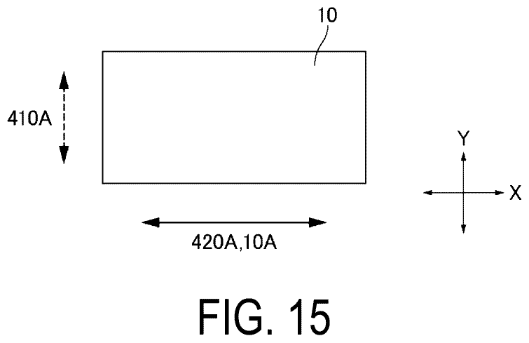

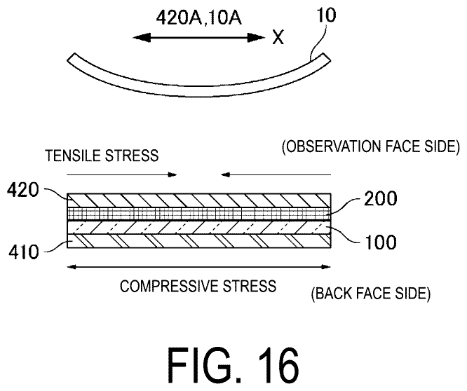

FIG. 13 is a schematic plan view illustrating stress relief in the display panels according to Example 1-1 and Example 1-2. FIG. 14 is a schematic cross-sectional view illustrating stress relief in the display panels according to Example 1-1 and Example 1-2. FIG. 15 is a schematic plan view illustrating stress relief in a display panel according to Example 2. FIG. 16 is a schematic cross-sectional view illustrating stress relief in the display panel according to Example 2. The right part of FIG. 14 is an enlarged schematic cross-sectional view of the left part of FIG. 14, and the “observation face side” and the “back face side” in FIG. 14 correspond to the enlarged schematic cross-sectional view on the right side. The lower part of FIG. 16 is an enlarged schematic cross-sectional view of the upper part of FIG. 16, and the “observation face side” and the “back face side” in FIG. 16 correspond to the enlarged schematic cross-sectional view of the lower side.

As illustrated in FIGS. 13 to 16, when the display panel 1 including the first absorptive polarizer 410 and the second absorptive polarizer 420 is curved, a neutral plane is the center (the liquid crystal layer 300) of the display panel 1. The stress applied to the display panel 1 is such that planes of a compressive stress and a tensile stress are opposite between the convex bending and the concave bending, but the direction of the stress coincides with the bending direction. In contrast, the shrinkage of the absorptive polarizer due to heat occurs in the absorption axis (stretching) direction. Therefore, the display panels 1 of Example 1-1, Example 1-2, Example 2-1, and Example 2-2 can suppress the biaxial deformation of the display panel 1 and reduce the light leakage due to photoelasticity by alleviating the influence of the shrinkage stress of the first absorptive polarizer 410 having the absorption axis direction orthogonal to the bending direction. Specifically, by relieving the heat shrinkage stress of the polarizer on the CF substrate side disposed on the observation face side in Example 1-1 and Example 1-2, and by relieving the heat shrinkage stress of the polarizer on the TFT substrate side disposed on the back face side in Example 2-1 and Example 2-2, the biaxial deformation of the display panel 1 can be suppressed, and the light leakage due to the photoelasticity can be reduced.

### Comparative Example 2 to Comparative Example 6

The display panels of Comparative Examples 2 to 6 have the same configuration as that of Example 1-1 except that the configurations of the adhesive layer 500 and the stress relief film 600 have the configurations shown in Table 4 below. Note that the heat shrinkage rate in Table 4 below is a heat shrinkage rate at a temperature in a range from 23° C. to 95° C. in a direction parallel to the absorption axis of the first absorptive polarizer.

TABLE 4

| | | | Location of |
|---|---|---|---|
| | Adhesive | | adhesive layer and |
| | layer | Stress relief film | stress relief film |
| Comparative | Elastic | Film having larger | First absorptive |
| Example 2 | modulus | heat shrinkage rate | polarizer |
| | 1 × 10⁵ Pa | than first | |
| | or less | absorptive polarizer | |
| Comparative | Elastic | Film having smaller | First absorptive |
| Example 3 | modulus | heat shrinkage rate | polarizer |
| | Greater than | than first | |
| | 1 × 10⁵ Pa | absorptive polarizer | |
| Comparative | Elastic | Film having smaller | Second absorptive |
| Example 4 | modulus | heat shrinkage rate | polarizer |
| | 1 × 10⁵ Pa | than first | |
| | or less | absorptive polarizer | |
| Comparative | Elastic | Film having larger | Second absorptive |
| Example 5 | modulus | heat shrinkage rate | polarizer |
| | 1 × 10⁵ Pa | than first | |
| | or less | absorptive polarizer | |
| Comparative | Elastic | Film having smaller | Second absorptive |
| Example 6 | modulus | heat shrinkage rate | polarizer |
| | Greater than | than first | |
| | 1 × 10⁵ Pa | absorptive polarizer | |

It is considered that the display panels of Comparative Examples 2 to 6 cannot sufficiently suppress light leakage occurring at the corners of the screen during black display.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display panel comprising:
a screen having a curvature in a first direction;
a first absorptive polarizer having an absorption axis orthogonal to the first direction, a first substrate, a liquid crystal layer, a second substrate, and a second absorptive polarizer in this order; and further comprising
an adhesive layer having an elastic modulus of 1×10⁵ Pa or less at a temperature of 23° C. and a stress relief film between the first absorptive polarizer and the first substrate,
wherein the stress relief film has a smaller heat shrinkage rate than the first absorptive polarizer at a temperature in a range from 23° C. to 95° C. in a direction parallel to the absorption axis of the first absorptive polarizer.

2. The display panel according to claim 1,
wherein the first direction is a short-side direction of the screen,
the screen has a curved shape with a central portion protruding toward an observation face side, and
the first substrate is located on a side of the screen of the liquid crystal layer.

3. The display panel according to claim 1,
wherein the first direction is a longitudinal direction of the screen,
the screen has a curved shape with a central portion protruding toward a back face side, and
the first substrate is located on a back face side of the liquid crystal layer.

4. The display panel according to claim 1,
wherein a thickness of the adhesive layer is 0.015 mm or more and 0.25 mm or less.

5. The display panel according to claim 1,
wherein a thickness of the stress relief film is 0.01 mm or more and 0.1 mm or less.

6. The display panel according to claim 1,
wherein the stress relief film does not have a phase difference.
